(19) United States
(12) Patent Application Publication
(10) Pub. No.: US 2019/0299735 A1
(43) Pub. Date: Oct. 3, 2019

(54) ACTIVE REGENERATIVE DAMPER SYSTEM

(71) Applicant: AISIN TECHNICAL CENTER OF AMERICA, INC., Northville, MI (US)

(72) Inventor: Corey Zwegers, Northville, MI (US)

(73) Assignee: AISIN TECHNICAL CENTER OF AMERICA, INC., Northville, MI (US)

(21) Appl. No.: 15/941,738

(22) Filed: Mar. 30, 2018

(51) Int. Cl. B60G 13/14; B60G 17/015; F16H 25/22; H02K 7/06

(52) U.S. Cl. CPC B60G 13/14; B60G 17/0157; F16H 25/2204; B60G 2400/64; B60G 2300/60; B60G 2202/42; B60G 2202/312; H02K 7/06

(57) ABSTRACT

A damper assembly to harvest energy from road deflections including a housing with a first shell, a second shell affixed to the first shell and to a vehicle body, a generator assembly with a first generator nested in the first shell, and a second generator nested in the second shell, a ball screw crossing the housing and with a first terminal portion that protrudes from the first shell and affixed to a wheel assembly of the vehicle, a second terminal portion that protrudes from the second shell, and a central portion extending between the first terminal portion and the second terminal portion, wherein the central portion actuates the first generator to provide a first electrical current when the wheel assembly is displaced in a first direction and the second generator to provide a second electrical current when the wheel assembly is displaced in a second direction.

### BACKGROUND

### Field of the Disclosure

The present disclosure relates to damper systems and particularly to damper systems that harvest energy from road imperfections.

### Description of the Related Art

In today's automotive industry, producing vehicles that maximize fuel economy and comfort is essential.

Such a demand in fuel economy and comfort can be addressed with energy recovery systems that harvest energy that would be otherwise wasted by being transferred and/or evacuated to the external environment.

To this end, conventional recovery systems can be placed throughout a drive train and/or suspension system of the vehicle to harvest energy wasted due to interactions between the vehicle and the road, and notably interactions between the vehicle and road imperfections, e.g. potholes, speed bumps, gravel, or the like.

For example, conventional recovery systems that are linked to suspension systems of the vehicle and that rely on complex hydraulic systems and/or circuit, e.g. gas springs, gas filled shock absorbers, and/or turbines, to harvest energy from road imperfections, have been proposed.

Although such conventional recovery systems are widely known to harvest wasted energy from road imperfections, they present important drawbacks in providing a reliable, cost efficient, and active way to harvest as well as actively control vehicle suspension and/or comfort due to the complex hydraulic systems and/or circuits relied upon.

Thus, a suspension system harvesting energy from road imperfections and solving the aforementioned limitations of reliability and active control is desired.

### SUMMARY

Accordingly, the object of the present disclosure is to provide a suspension energy recovery system which overcomes the above-mentioned limitations.

To provide reliability and active control the suspension energy recovery system relies on an electromechanical system that harvest road imperfections, e.g. potholes, bumps, or the like. More precisely, the suspension energy recovery system relies on a ball screw that undergoes rectilinear displacements due to the road imperfections, such as positive deflections, e.g. bumps, and negative deflections, e.g. pothole, and a generator assembly that is directly actuated by the ball screw to harvest the rectilinear displacements and produce electrical energy. The generator assembly includes a compression generator that harvests displacements of the ball screw in a first direction, e.g. upward direction caused by the positive deflections of the road, and an extension generator that harvests displacements of the ball screw in a second direction opposite to the first direction, e.g. downward direction caused by the negative deflections of the road.

In one non-limiting illustrative example, an energy recovery suspension system for a vehicle is presented. The energy recovery suspension system includes a wheel assembly that undergoes displacements due to road imperfections, a damper assembly linked to the wheel assembly, the damper assembly including a generator assembly, and a ball screw assembly connected to the wheel assembly that follows the displacements of the wheel assembly and actuates the generator assembly to provide electricity, and a control assembly configured to detect the displacements, measure amplitudes of the displacement, and provide actuation signals to the generator assembly based on the measured amplitudes to damp the displacements.

In another non-limiting illustrative example, a damper assembly for a vehicle to harvest energy from road imperfections is presented. The damper assembly includes a housing including a first shell, a second shell affixed to the first shell and to a body of the vehicle, a generator assembly including a first generator nested in the first shell, and a second generator nested in the second shell, a ball screw crossing the housing and including a first terminal portion that protrudes from the first shell and affixed to a wheel assembly of the vehicle, a second terminal portion that protrudes from the second shell, and a central portion extending between the first terminal portion and the second terminal portion, wherein the central portion actuates the first generator to provide a first electrical current when the wheel assembly is displaced in a first direction, and the second generator to provide a second electrical current when the wheel assembly is displaced in a second direction opposite to the first direction.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a perspective view of an energy recovery suspension system over a positive deflection, according to certain aspects of the disclosure;

FIG. 1B is a perspective view of the energy recovery suspension system over a negative deflection, according to certain aspects of the disclosure;

FIG. 2A is a perspective view of a damper assembly of the energy recovery suspension system, according to certain aspects of the disclosure;

FIG. 2B is a sectional view of the damper assembly of the energy recovery suspension system, according to certain aspects of the disclosure;

FIG. 3 is a schematic view of a control assembly of the energy recovery suspension system, according to certain aspects of the disclosure;

FIG. 4 is a flow chart of a method to actively operate the energy recovery suspension system, according to certain aspects of the disclosure; and

FIG. 5 is a schematic view of a hardware diagram of an electrical control unit of the control assembly, according to certain aspects of the disclosure.

### DETAILED DESCRIPTION

All publications, patent applications, patents, and other references mentioned herein are incorporated by reference in their entirety. Further, the materials, methods, and examples discussed herein are illustrative only and are not intended to be limiting.

In the drawings, like reference numerals designate identical or corresponding parts throughout the several views. Further, as used herein, the words “a”, “an”, and the like include a meaning of “one or more”, unless stated otherwise. The drawings are generally drawn not to scale unless specified otherwise or illustrating schematic structures or flowcharts.

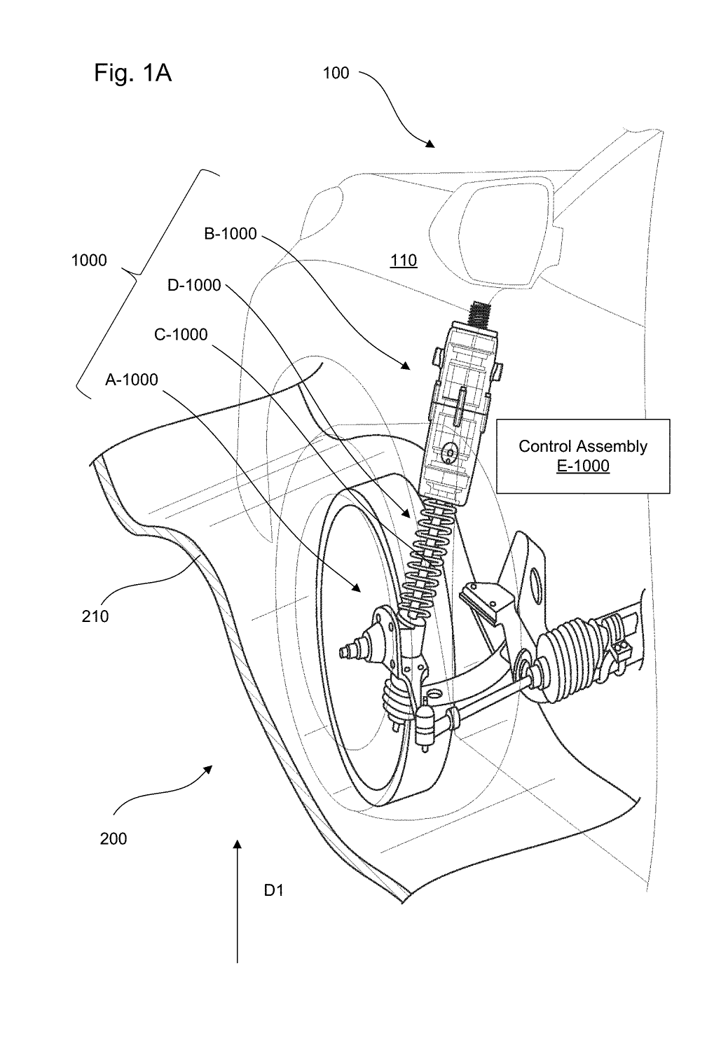

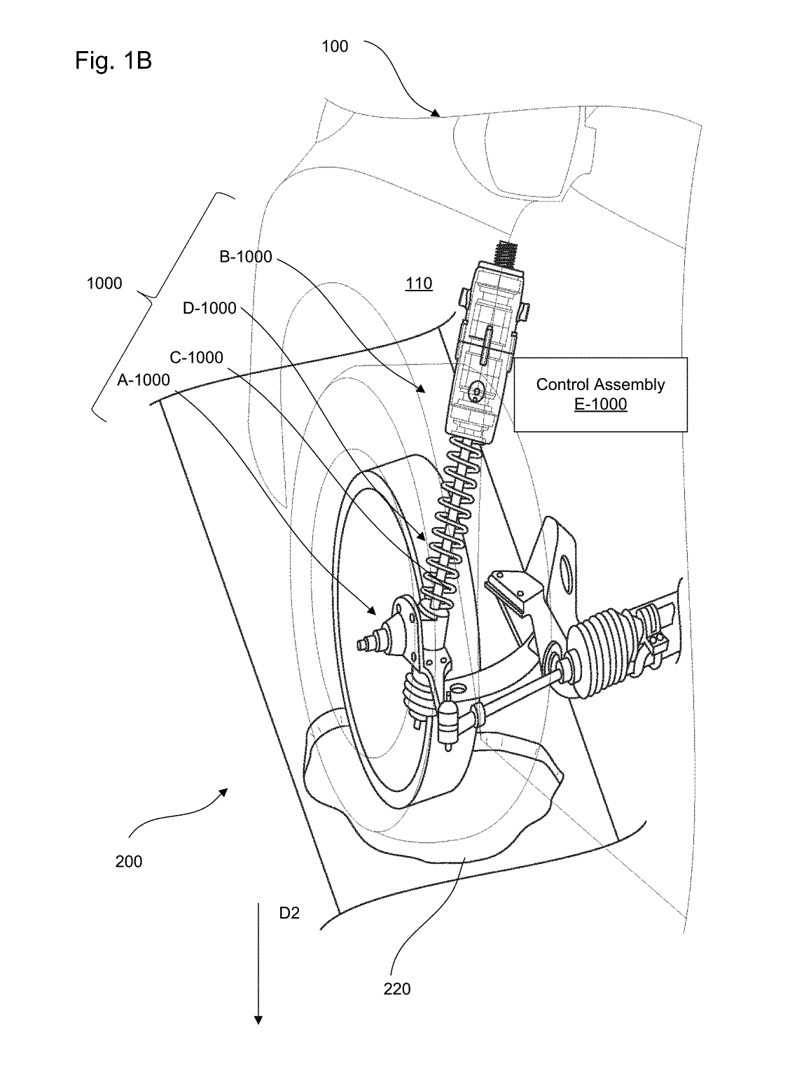

FIGS. 1A-1B are perspective views of an energy recovery suspension system 1000 going over positive deflections 210 and over negative deflections 220, according to certain aspects of the disclosure.

The energy recovery suspension system 1000 can include a wheel assembly A-1000, a damper assembly B-1000 affixed to a body 110 of the vehicle 100, a strut assembly C-1000 extending between the wheel assembly A-1000 and the damper assembly B-1000, a spring assembly D-1000 surrounding the strut assembly C-1000 and extending between the wheel assembly A-1000 and the damper assembly B-1000, and a control assembly E-1000 operatively connected to the damper assembly B-1000.

The wheel assembly A-1000 can provide motion, traction, propulsion, and/or steering of the vehicle 100 while the vehicle 100 is rolling over a road 200 with positive deflections 210, e.g. bumps, as illustrated in FIG. 1A, and negative deflections 220, e.g. potholes, as illustrated in FIG. 1B.

Under the passage of the wheel assembly A-1000 on the negative deflections 220 and the positive deflections 210, the strut assembly C-1000 transfers the negative deflections 220 and the positive deflections 210 to the spring assembly D-1000 and the damper assembly B-1000, and the damper assembly B-1000 is successively articulated between an compression state, as illustrated in FIG. 1A, and an extension state, as illustrated in FIG. 1B.

The damper assembly B-1000 harvests the successive articulations between the compression state and the extension state to produce electricity as well as to actively absorb the positive deflections 210 and the negative deflections 220 of the road 200 and provide comfort to passengers of the vehicle 100.

The energy recovery suspension system 1000 provides a reliable way to harvest energy as well as to actively control suspension of the vehicle 100 by relying on electromechanical interactions between the damper assembly B-1000 and the wheel assembly A-1000.

As used herein, the term “lower” refers to the region of the energy recovery suspension system 1000 closest to the road 200, while the term “upper” refers to the region of the energy recovery suspension system 1000 furthest from the road 200.

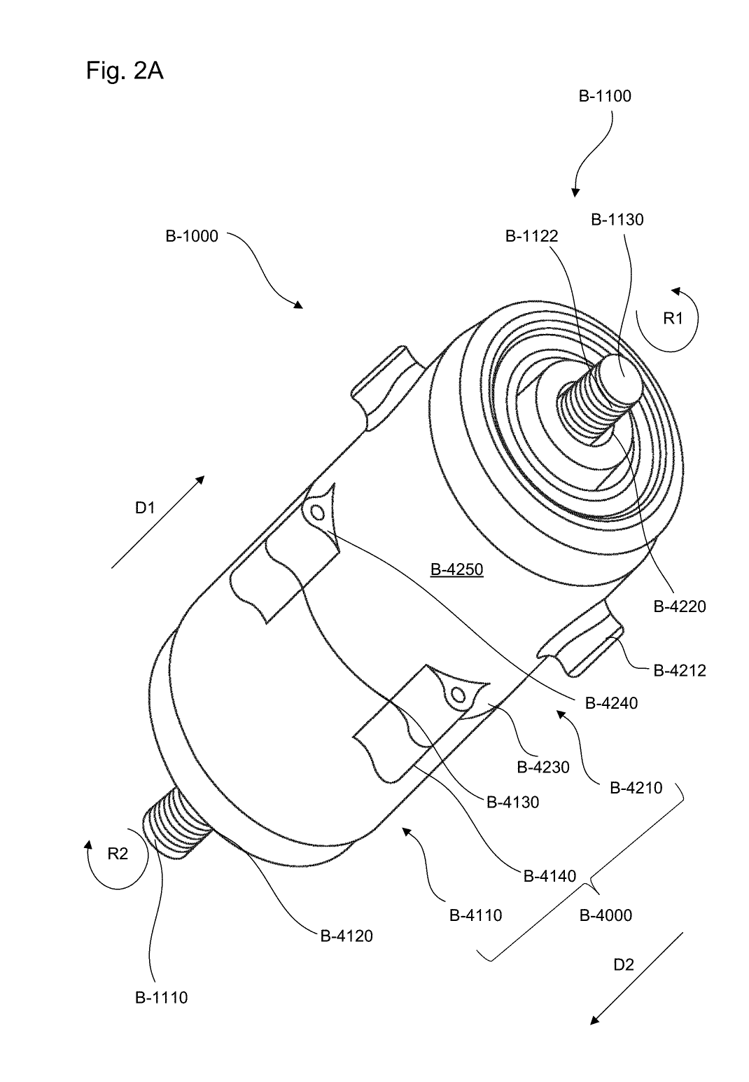

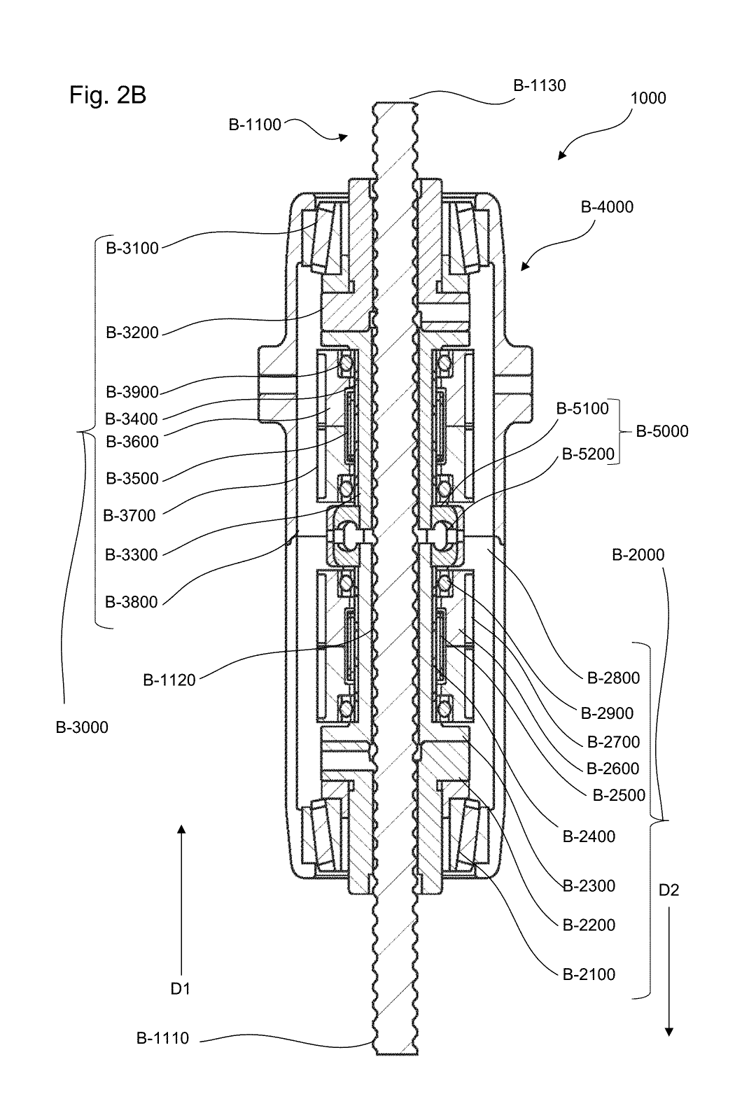

FIGS. 2A-2B are a perspective and a sectional views of the damper assembly B-1000 of the energy recovery suspension system 1000, according to certain aspects of the disclosure.

The damper assembly include a ball screw B-1100 linked to the strut assembly C-1000, a compression generator B-2000 and an extension generator B-3000 slidably affixed around the ball screw B-1100, a housing B-4000 that encloses the compression generator B-2000 and the extension generator B-3000 and is affixed to a body 110 of the vehicle 100, as illustrated in FIGS. 1A-1B.

The housing B-4000 can include a lower housing shell B-4110 that encloses the compression generator B-2000 and an upper housing shell B-4210 that encloses the extension generator B-3000 and is affixed to the support structure of the vehicle 100, as illustrated in FIGS. 1A-1B.

The upper housing shell B-4210 can include a plurality of mounts B-4212 that protrudes from an external housing surface B-4250 of the upper housing shell B-4210 to provide support between the housing B-4000 and the vehicle 100, an upper housing hole B-4220 to receive the ball screw B-1100, an upper housing lip B-4230, and a plurality of upper housing bosses B-4240 positioned radially around the upper housing lip B-4230.

The lower housing shell B-4110 can include a lower housing hole B-4120 to receive the ball screw B-1100, a lower housing lip B-4130 to match and contact the upper housing lip B-4230, and a plurality of lower housing bosses B-4140 positioned radially around the lower housing lip B-4130 to match and contact the plurality of upper housing bosses B-4240.

In addition, a plurality of fastening devices, e.g. screws, bolts, rivets, or the like, can be inserted through the plurality of upper housing bosses B-4240 and the plurality of lower housing bosses B-4140 to push the lower housing lip B-4130 and the upper housing lip B-4230 against each other to encapsulate the compression generator B-2000 and the extension generator B-3000.

The ball screw B-1100 can include a lower terminal portion B-1110 that protrudes from the lower housing hole B-4120 and is affixed to the strut assembly C-1000, an upper terminal portion B-1130 that freely protrudes from the upper housing hole B-4220, and a central portion B-1120 that extends between the upper housing hole B-4220 and the lower housing hole B-4120 and through the lower housing lip B-4130 and the upper housing lip B-4230 and slides along the compression generator B-2000 and the extension generator B-3000.

In addition, the central portion B-1120 can include an external surface B-1122 with threads to provide mechanical interactions with the compression generator B-2000 and the extension generator B-3000.

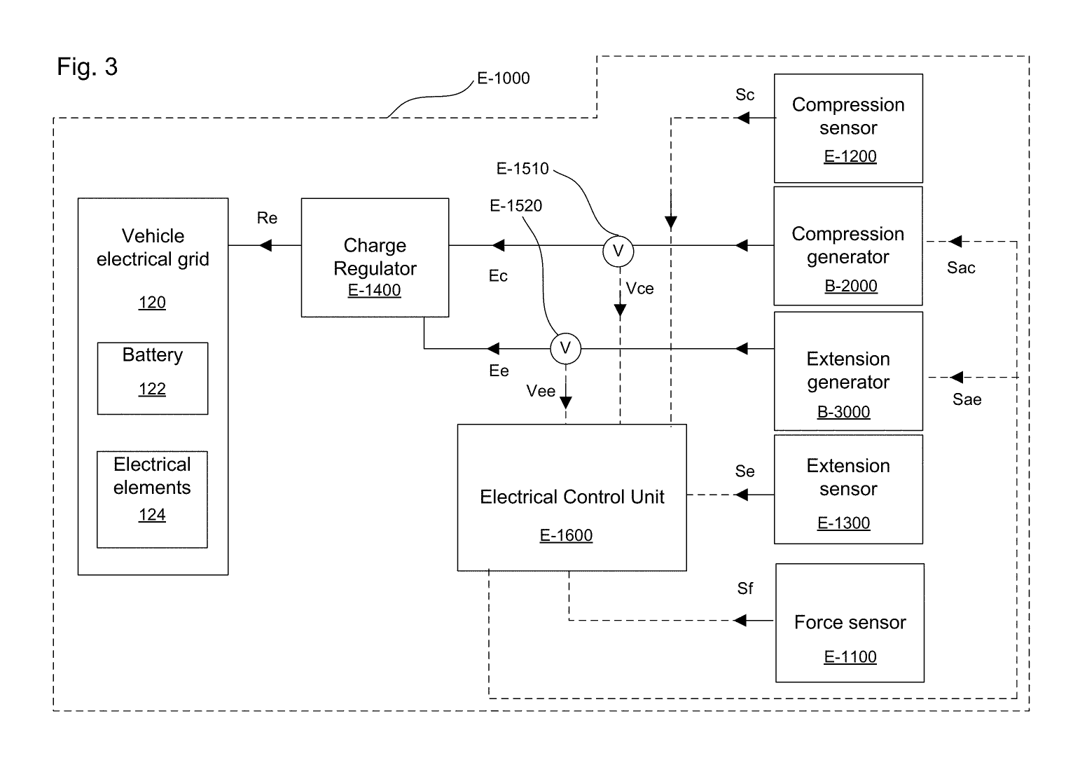

As the wheel assembly A-1000 goes over the positive deflections 210, the lower terminal portion B-1110 of the ball screw B-1100 is pushed in a first direction D1, e.g. upward direction, through the upper housing hole B-4220. The central portion B-1120 of the ball screw B-1100 slides through the compression generator B-2000 and the extension generator B-3000 to only actuate the compression generator B-2000 and generate compression electricity Ec, as illustrated in FIG. 3.

Inversely, as the wheel assembly A-1000 goes over the negative deflections 220, the lower terminal portion B-1110 of the ball screw B-1100 is pushed in a second direction D2, e.g. downward direction, through the upper housing hole B-4220. The central portion B-1120 of the ball screw B-1100 slides through the extension generator B-3000 and the compression generator B-2000 to only actuate the extension generator B-3000 and generate extension electricity Ee, as illustrated in FIG. 3.

The compression generator B-2000 can include lower tapered bearings B-2100 that seats on the lower housing hole B-4120, a lower ball nut B-2200 that seats on the lower tapered bearings B-2100 and is crossed by the lower terminal portion B-1110 of the ball screw B-1100, a lower drive shaft B-2300 that seats on the lower ball nut B-2200 and is partially crossed by the central portion B-1120 of the ball screw B-1100, a lower sleeve B-2400 that surrounds the lower drive shaft B-2300, a lower clutch B-2500 that is affixed to the lower drive shaft B-2300, a lower rotor core B-2600 that is linked to the lower drive shaft B-2300 via the lower clutch B-2500, a plurality of lower magnets B-2700 radially positioned around the lower rotor core B-2600, a lower stator B-2800 that surrounds the plurality of lower magnets B-2700, and lower rotor bearings B-2900 positioned between the lower rotor core B-2600 and the lower sleeve B-2400.

The lower tapered bearings B-2100 can provide rotation between the lower housing shell B-4110 and the lower ball nut B-2200 and reduce friction between the lower housing shell B-4110 and the lower ball nut B-2200.

The lower ball nut B-2200 can provide support for the lower terminal portion B-1110 and the central terminal portion of the ball screw B-1100.

The lower drive shaft B-2300 can provide rotation in a first rotation direction, e.g. clockwise, as the ball screw B-1100 is moved in the first direction D1 and provide rotation in a second rotation direction, e.g. counter-clockwise, as the ball screw B-1100 is moved in the second direction D2.

The lower clutch B-2500 can be configured to transmit the rotation of the lower drive shaft B-2300 to the lower rotor core B-2600 when the lower drive shaft B-2300 rotates in the first rotation direction R1 and to prevent the rotation of the lower rotor core B-2600 when he lower drive shaft B-2300 rotates in the second rotation direction R2.

The lower rotor core B-2600 and the plurality of lower magnets B-2700 can electromagnetically interact with the lower stator B-2800 to generate the compression electricity Ec.

Similarly, the extension generator B-3000 can include upper tapered bearings B-3100 that seats on the upper housing hole B-4220, a upper ball nut B-3200 that seats on the upper tapered bearings B-3100 and is crossed by the upper terminal portion B-1130 of the ball screw B-1100, a upper drive shaft B-3300 that seats on the upper ball nut B-3200 and is partially crossed by the central portion B-1120 of the ball screw B-1100, a upper sleeve B-3400 that surrounds the upper drive shaft B-3300, a upper clutch B-3500 that is affixed to the lower drive shaft B-2300, a upper rotor core B-3600 that is linked to the upper drive shaft B-3300 via the upper clutch B-3500, a plurality of upper magnets B-3700 radially positioned around the upper rotor core B-3600, a upper stator B-3800 that surrounds the plurality of upper magnets B-3700, and upper rotor bearings B-3900 positioned between the upper rotor core B-3600 and the upper sleeve B-3400.

The upper tapered bearings B-3100 can provide rotation between the upper housing shell B-4210 and the upper ball nut B-3200 and reduce friction between the upper housing shell B-4210 and the upper ball nut B-3200.

The upper ball nut B-3200 can provide support for the upper terminal portion B-1130 and central terminal portion of the ball screw B-1100.

The upper drive shaft B-3300 can provide rotation in the first rotation direction as the ball screw B-1100 is moved in the first direction D1 and provide rotation in the second rotation direction as the ball screw B-1100 is moved in the second direction D2.

The upper clutch B-3500 can be configured to transmit the rotation of the upper drive shaft B-3300 to the upper rotor core B-3600 when the upper drive shaft B-3300 rotates in the second rotation direction R2 and to prevent the rotation of the upper rotor core B-3600 when the rotation of the upper drive shaft B-3300 rotates in the first rotation direction R1.

The upper rotor core B-3600 and the plurality of upper magnets B-3700 can electromagnetically interact with the upper stator B-3800 to generate the extension electricity Ee.

In addition, the damper assembly B-1000 can include a inter generator assembly B-5000 positioned between the compression generator B-2000 and the extension generator B-3000 to provide support and allow the compression generator B-2000 and the extension generator B-3000 to be actuated by the ball screw B-1100 independently.

The inter generator assembly B-5000 can include a pair of spacers B-5100 sandwiched between the lower drive shaft B-2300 and the upper drive shaft B-3300 and a thrust bearing B-5200 positioned between the pair of spacers B-5100 to provide independent rotation between the lower drive shaft B-2300 and the upper drive shaft B-3300.

As the vehicle 100 goes over the positive deflections 210, the lower terminal portion B-1110 is pushed through the lower ball nut B-2200 and the upper terminal portion B-1130 is pushed through the upper ball nut B-3200 in the first direction D1 which in turn force the lower drive shaft B-2300 and the upper drive shaft B-3300 to rotate in a first rotation direction R1, e.g. clockwise. The lower clutch B-2500 transmit the rotational motion of the lower drive shaft B-2300 to the lower rotor core B-2600 and the plurality of lower magnets B-2700, while the upper clutch B-3500 does not transmit the rotational motion of the upper drive shaft B-3300 to the upper rotor core B-3600 and the plurality of upper magnets B-3700.

The plurality of lower magnets B-2700 rotates, and electromagnetically interacts with the lower stator B-2800 to generate the compression electricity Ec, while the plurality of upper magnets B-3700 stay steady, to not electromagnetically interact with the upper stator B-3800 and to not generate the extension electricity Ee, as illustrated in FIG. 3.

Inversely, as the vehicle 100 goes over the negative deflections 220, the lower terminal portion B-1110 is pulled through the lower ball nut B-2200 and the upper terminal portion B-1130 is pulled through the upper ball nut B-3200 in the second direction D2 which in turn force the lower drive shaft B-2300 and the upper drive shaft B-3300 to rotate in a second rotation direction R2 opposite to the first rotation direction R1, e.g. counter-clockwise.

The lower clutch B-2500 does not transmit the rotational motion of the lower drive shaft B-2300 to the lower rotor core B-2600 and the plurality of lower magnets B-2700, while the upper clutch B-3500 transmits the rotational motion of the upper drive shaft B-3300 to the upper rotor core B-3600 and the plurality of upper magnets B-3700.

The plurality of upper magnets B-3700 rotates and electromagnetically interacts with the plurality of upper magnets B-3700 and the upper stator B-3800 to generate the extension electricity Ee, as illustrated in FIG. 3, while the plurality of lower magnets B-2700 stays steady and do not electromagnetically interact with the lower stator B-2800 and produce the compression electricity Ec, as illustrated in FIG. 3.

FIG. 3 is a schematic view of a control assembly of the active regenerative damper system, according to certain aspects of the disclosure;

The control assembly E-1000 is configured to harvest energy from the positive deflections 210 and negative deflections 220 and actively control the damper assembly B-1000 via feedback to absorb the positive deflections 210 and the negative deflections 220 of the road 200 and to provide comfort to passengers of the vehicle 100.

The control assembly E-1000 can include a force sensor E-1100, a compression sensor E-1200, an extension sensor E-1300, a charge regulator E-1400, a compression voltmeter E-1510, an extension voltmeter E-1520, and an electrical control unit E-1600 operatively coupled to the force sensor E-1100, the extension sensor E-1300, the compression sensor E-1200, the charge regulator E-1400, the compression voltmeter E-1510, the extension voltmeter E-1520, the compression generator B-2000, and the extension generator B-3000.

The force sensor E-1100 can be any sensor configured to provide force signals Sf commensurate with amplitudes of the positive deflections 210 and the negative deflections 220 of the road 200 and positioned on a structure of the energy recovery suspension system 1000 that is articulated by the positive deflections 210 and/or the negative deflections 220. For example, the force sensor E-1100 can be a strain gauge positioned on an arm of the wheel assembly A-1000 and/or on the spring assembly D-1000, a pressure sensor positioned on a tire of the wheel assembly A-1000, or the like.

The extension sensor E-1300 can be any sensor configured to provide extension signals Se commensurate with a displacement of the ball screw B-1100 in the second direction D2, as illustrated in FIG. 1B. For example, the extension sensor E-1300 can be a rotary encoder, e.g. optical, magnetic and/or capacitive encoders, positioned on an upper portion of the extension generator B-3000 and around the ball screw B-1100.

Similarly, the compression sensor E-1200 can be any sensor configured to provide compression signals Sc commensurate with a displacement of the ball screw B-1100 in the first direction D1, as illustrated in FIG. 1A. For example, the compression sensor E-1200 can be a rotary encoder, e.g. optical, magnetic and/or capacitive encoders, positioned on a lower portion of the compression generator B-2000 and around the ball screw B-1100.

The charge regulator E-1400 can be configured to receive the compression electricity Ec from the compression generator B-2000 and the extension electricity Ee from the extension generator B-3000, and regulate the compression electricity Ec and the extension electricity Ee to provide a regulated electricity Re to an electrical grid 120 of the vehicle 100.

The charge regulator E-1400 can prevent transferring over voltages to the electrical grid 120 to enhance electrical grid 120 performances and lifespan by providing the regulated electricity Re as an average of the compression electricity Ec and the extension electricity Ee over a predetermined period of time. The charge regulator E-1400 can be a stand-alone device, as illustrated in FIG. 3, or circuitry integrated to the electrical grid 120. To provide the regulated electricity Re, the charge regulator E-1400 can rely on Pulse Width Modulation (PWM) and/or Maximum Power Point-Tracker (MPPT) technologies.

The electrical grid 120 of the vehicle 100 can be any electrical system and/or circuit configured to use and/or store electrical power. For example, the electrical grid 120 can include a battery 122 electrically connected to electrical elements 124 of the vehicle 100, e.g. electrical motors, electrical light emitting device.

The compression voltmeter E-1510 can be configured to provide compression voltage signals Vce commensurate with voltage values of the compression electricity Ec, while the extension voltmeter E-1520 can be configured to provide extension voltage signals Vee commensurate with voltage values of the extension electricity Ee.

The electrical control unit E-1600 can be configured to monitor and control the damper assembly B-1000 by receiving the compression signals Sc from the compression sensor E-1200, the extension signals Se from the compression sensor E-1200, the force signals Sf from the force sensors E-1100, and providing compression actuation signals Sac to the compression generator B-2000 to absorb the positive deflections 210 and extension actuation signals Sae to the extension generator Sae to absorb the negative deflections 220.

The electrical control unit E-1600 and functionalities associated with the electrical control unit E-1600 will be described in details in following paragraphs and figures.

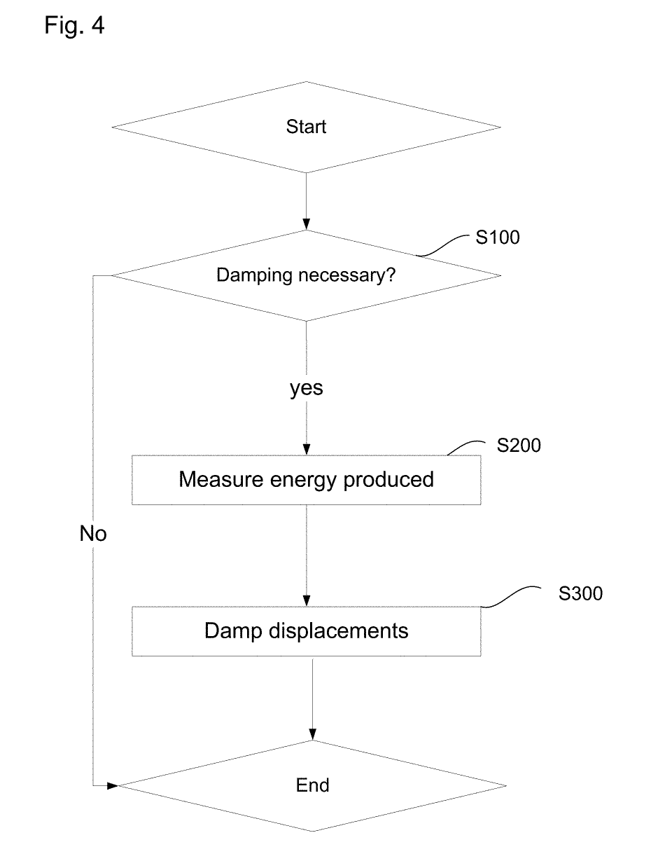

FIG. 4 is a flow chart of a method to actively operate the energy recovery suspension system 1000, according to certain aspects of the disclosure.

In a step S100, it is determined if active damping of the vehicle 100 is necessary through the force sensor E-1100 and software instructions executed by the electrical control unit E-1600.

For example, the electrical control unit E-1600 can be configured to receive the force signals Sf from the force sensor E-1100 and software instructions can be written to extract amplitude values of the positive deflections 210 and the negative deflections 220 based on the force signals Sf and compare the amplitude values to predetermined amplitude thresholds A0. If the amplitude values are above the predetermined amplitude thresholds it is determined that active damping is necessary and the process goes to a step S200. Otherwise, the process stops.

In the step S200, energy produced by the compression generator B-2000 and the extension generator B-3000 is measured through the compression voltmeter E-1510, the extension voltmeter E-1520, and software instructions executed on the electrical control unit E-1600.

For example, the electrical control unit E-1600 can be configured to receive compression voltage signals Vce from the compression voltmeter E-1510 and the software instructions can be written to extract compression voltage values based on the compression voltage signals Vce.

Similarly, the electrical control unit E-1600 can be configured to receive extension voltage signals Vee from the extension voltmeter E-1520 and the software instructions can be written to extract extension voltage values based on the extension voltage signals Vee.

In a step S300, feedback to actively damp the positive deflections 210 and the negative deflections 220 is performed through the extension generator B-3000 and the compression generator B-2000, as well as through software instructions executed on the electrical control unit E-1600.

For example, the electrical control unit E-1600 can be configured to provide to the extension generator B-3000 extension actuation signals Sae based on the compression voltage values measured in the step S200 to damp displacements of the wheel assembly A-1000 in the first direction D1 due to positive deflections 210, as illustrated in FIG. 1A.

Similarly, the electrical control unit E-1600 can be configured to provide to the compression generator B-2000 compression actuation signals Sac based on the extension voltage values measured in the step S200 to damp displacements of the wheel assembly A-1000 in the second direction D2 due to negative deflections 220, as illustrated in FIG. 1B.

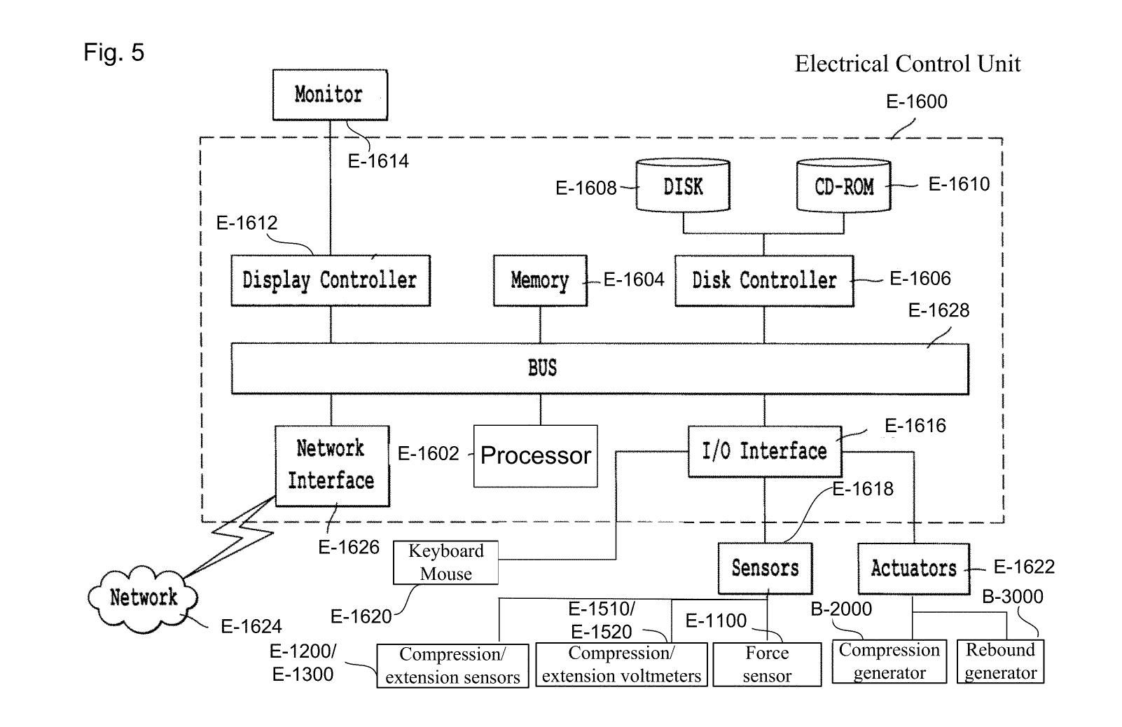

FIG. 5 is a schematic view of a hardware diagram of an electrical control unit E-1600 of the control assembly E-1000, according to certain aspects of the disclosure.

As shown in FIG. 5, systems, operations, and processes in accordance with this disclosure may be implemented using a processor E-1602 or at least one application specific processor (ASP). The processor E-1602 may utilize a computer readable storage medium, such as a memory E-1604 (e.g., ROM, EPROM, EEPROM, flash memory, static memory, DRAM, SDRAM, and their equivalents), configured to control the processor E-1602 to perform and/or control the systems, operations, and processes of this disclosure. Other storage mediums may be controlled via a disk controller E-1606, which may control a hard disk drive E-1608 or optical disk drive E-1610.

The processor E-1602 or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The processor E-1602 may be a separate device or a single processing mechanism. Further, this disclosure may benefit form parallel processing capabilities of a multi-cored processor.

In another aspect, results of processing in accordance with this disclosure may be displayed via a display controller E-1612 to a monitor E-1614 that may be peripheral to or part of the electrical control unit E-1600. Moreover, the monitor E-1614 may be provided with a touch-sensitive interface to a command/instruction interface. The display controller E-1612 may also include at least one graphic processing unit for improved computational efficiency. Additionally, the electrical control unit E-1600 may include an I/O (input/output) interface E-1616, provided for inputting sensor data from sensors E-1618 and for outputting orders to actuators E-1622. The sensors E-1618 and actuators E-1622 are illustrative of any of the sensors and actuators described in this disclosure. For example, the sensors E-1618 can include the force sensor E-1100, the compression sensor E-1200, the extension sensor E-1300, and/or the compression voltmeter E-1510, the extension voltmeter E-1520, while the actuators E-1622 can include the compression generator B-2000 and/or the extension generator B-3000.

Further, other input devices may be connected to an I/O interface E-1616 as peripherals or as part of the electrical control unit E-1600. For example, a keyboard or a pointing device such as a mouse E-1620 may control parameters of the various processes and algorithms of this disclosure, and may be connected to the I/O interface E-1616 to provide additional functionality and configuration options, or to control display characteristics. Actuators E-1622 which may be embodied in any of the elements of the apparatuses described in this disclosure may also be connected to the I/O interface E-1616.

The above-noted hardware components may be coupled to the network E-1624, such as the Internet or a local intranet, via a network interface E-1626 for the transmission or reception of data, including controllable parameters to a mobile device. A central BUS E-1628 may be provided to connect the above-noted hardware components together, and to provide at least one path for digital communication there between.

The foregoing discussion discloses and describes merely exemplary embodiments of an object of the present disclosure. As will be understood by those skilled in the art, an object of the present disclosure may be embodied in other specific forms without departing from the spirit or essential characteristics thereof. Accordingly, the present disclosure is intended to be illustrative, but not limiting of the scope of an object of the present disclosure as well as the claims.

Numerous modifications and variations on the present disclosure are possible in light of the above teachings. It is therefore to be understood that within the scope of the appended claims, the disclosure may be practiced otherwise than as specifically described herein.

What is claimed is:

1. An energy recovery suspension system for a vehicle, comprising:
a wheel assembly;
a damper assembly linked to the wheel assembly, the damper assembly including a generator assembly, and a ball screw assembly connected to the wheel assembly that follows displacements of the wheel assembly and actuates the generator assembly to provide electricity; and
a control assembly configured to
detect the displacements,
measure amplitudes of the displacement, and
provide actuation signals to the generator assembly based on the measured amplitudes to damp the displacements, wherein
the generator assembly includes a first generator actuated by the ball screw when the displacements are in a first direction, and a second generator actuated by the ball screw when the displacements are in a second direction opposite to the first direction,
the first generator is connected to the ball screw through a first clutch configured to allow transmission of the displacements in the first direction from the ball screw to the first generator and prevent transmission of the displacements in the second direction from the ball screw to the first generator, and
the second generator is connected to the ball screw through a second clutch configured to allow transmission of the displacements in the second direction from the ball screw to the second generator and prevent transmission of the displacements in the first direction from the ball screw to the second generator.

2. The energy recovery suspension system of claim 1, wherein the control system includes a force sensor configured to provide force signals commensurate with the amplitudes of the displacements.

3. The energy recovery suspension system of claim 2, wherein the force sensor is a strain gauge positioned on an arm of the wheel assembly.

4. The energy recovery suspension system of claim 1, wherein the control assembly further includes:
a first displacement sensor positioned on a first terminal extremity of the ball screw to provide first direction signals commensurate with the displacements of the ball screw in the first direction, and
a second displacement sensor positioned on a second terminal extremity of the ball screw to provide second direction signals commensurate with the displacements of the ball screw in the second direction.

5. The energy recovery suspension system of claim 4, wherein the first displacement sensor and the second displacement sensor are rotary encoders.

6. The energy recovery suspension system of claim 1 further including a housing affixed to a body of the vehicle and enclosing the generator assembly.

7. The energy recovery suspension system of claim 6, wherein the housing includes a plurality of mounts that protrudes from an external surface of the housing to be affixed to the body.

8. A damper assembly for a vehicle, comprising:
a housing including a first shell, and a second shell affixed to both the first shell and to a body of the vehicle;
a generator assembly including a first generator in the first shell, and a second generator in the second shell;
a ball screw crossing the housing, the ball screw including a first terminal portion that protrudes from the first shell and affixed to a wheel assembly of the vehicle, a second terminal portion that protrudes from the second shell, and a central portion extending between the first terminal portion and the second terminal portion, wherein
the central portion actuates the first generator to provide a first electrical current when the wheel assembly is displaced in a first direction, and actuates the second generator to provide a second electrical current when the wheel assembly is displaced in a second direction opposite to the first direction,
the first generator is connected to the ball screw through a first clutch configured to transmit the displacement of the ball screw in the first direction and to not transmit the displacement of the wheel assembly in the second direction, and
the second generator is connected to the ball screw through a second clutch configured to transmit the displacement of the wheel assembly in the second direction and to not transmit the displacement of the wheel assembly in the first direction.

9. The damper assembly of claim 8, wherein the first generator includes a first drive shaft positioned between the central portion of the ball screw and the first shaft that rotates when ball screw is displaced in the first direction and the second direction.

10. The damper assembly of claim 8, wherein the second generator includes a second drive shaft positioned between the central portion of the ball screw and the second shaft that rotates when the ball screw is displaced in the first direction and the second direction.

11. The damper assembly of claim 8, wherein the second shell includes a plurality of mounts that protrudes from an external surface of the second shell to affix the housing to the body.

12. The damper assembly of claim 8, wherein the first shell includes a plurality of first bosses and the second shell includes a plurality of second bosses that match the plurality of first bosses to affix the first shell to the second shell.

13. The damper assembly of claim 8 further including an inter generator assembly to have the first generator and the second generator actuated independently.

14. The damper assembly of claim 13, wherein the inter generator assembly includes a thrust bearing between a pair of spacers.
